(19) United States
(12) Patent Application Publication
(10) Pub. No.: US 2006/0056322 A1
(43) Pub. Date: Mar. 16, 2006

(54) Method for updating a timer function in a mobile station in a wireless local area network

(76) Inventors: Floyd D. Simpson, Lake Worth, FL (US); Brian K. Smith, Wellington, FL (US); Huai Y. Wang, Coconut Creek, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/938,215

(22) Filed: Sep. 10, 2004

(51) Int. Cl. H04B 7/005; H04J 3/24

(52) U.S. Cl. 370/278; 370/329; 370/349

(57) ABSTRACT

A mobile station (204) in a wireless local area network is associated with an access point (202), which controls timing of certain transmissions, such as beacons (402). The mobile station has a timer (108) that is driven by a high frequency clock source (110) while operating in an active mode, and a low frequency clock source (112) when in a low power mode, to conserve battery charge. To prevent timing errors from significantly affecting the accuracy for the timer (108) upon transitioning from one mode to the other, access point transmits timing information to the mobile station in the course of servicing requests from the mobile station. The timing information is included in a response sequence (300).

### TECHNICAL FIELD

This invention relates in general to wireless local area networks, and more particularly to timing a synchronizing a mobile station's local timer while transitioning from a low power mode to an active mode in the course of servicing a traffic stream.

### BACKGROUND OF THE INVENTION

Wireless local area networks (WLANs) are becoming increasing common in both private and business enterprise settings. WLANs are being used increasingly for more than just conventional computer networking. For example, WLAN handsets, which are mobile communication devices operating over WLANs, provide voice calling functions similar to wireless and cellular telephony. The most popular technical specification describing operation of a WLAN is IEEE specification 802.11. In the 802.11 protocol, the fixed stations that connect wireless devices to wired or larger networks, known as access points (AP), and all the wireless stations in the Basic Service Set (BSS) are synchronized to a common timer established and distributed by the AP. The timer synchronization functionality (TSF) is accomplished through the TSFtimer value that the AP sends in periodic Beacon frames. The TSFtimer value is a copy of the present value of the access point's TSFtimer at the time the beacon is transmitted. Stations operating in the BSS use the TSFtimer received in beacon frames to adjust their own timers for synchronization.

To conserve power, stations, such as mobile communication devices, which are WLAN handsets, operating in a BSS may use the 802.11 power save mode. In power save mode stations may go into a low power mode, such as “doze” or “sleep” state where the station turns off its WLAN radio. While in the low power mode the station does not awaken to receive beacons or other AP transmissions. For example, a station may decide to only awaken to receive every second, third, forth, etc. beacon. To minimize power consumption, many WLAN chipsets support an even lower power consuming mode than the doze state or sleep state where the local higher current, high frequency, more accurate clock is turned off and a lower current, lower frequency, less precise timer is used to keep time while the WLAN radio is turned off. The lower frequency clock is then used to determine when the station would turn on the WLAN radio to receive a beacon or other signal occurring at a predetermined time.

In a Voice over IP over WLAN (VoWLAN) system, voice frames are sent and received at a regular intervals, typically about every 20 milliseconds. To increase the talk time and conserve battery life, it has been proposed that a VoWLAN station utilizes an Uplink poll-based power save delivery (UPSD) scheme. The UPSD scheme allows the station to use very low power states when not transacting with the AP. Because of the very fast transmission speeds used in WLAN and the short frame duration of voice packets, in any 20 ms interval the station could be in the low power mode for more than 80% of the 20 ms interval. Which means that the timer may be driven by the low frequency clock most of the time.

To conserve power, even when not in a WLAN call, the VoWLAN system can operate in a low power mode such that it wakes up only to receive certain beacons, such as beacons containing a delivery traffic information message (DTIM). The period between beacons containing the DTIM is an integer multiple of the beacon interval used by the AP. A typical beacon interval is 102.4 milliseconds, and a typical period for DTIM beacons is three times that, or 307.2 milliseconds.

As a result of operating in low power mode for relatively extended periods while using the lower resolution low frequency clock source, the station may fall out of synchronization with the AP in between DTIM beacons. As a result there may be a substantial timing error relative to the access point's time keeping. Such an error is also compounded in some implementations when the station is servicing using the UPSD mode because the station will be switching between the low frequency and high frequency clocks every 20 milliseconds, and the error is compounded with each clock switch. The error becomes a problem for stations waking up to receive expected, scheduled events from their serving and neighbor access points. For example, in some VoWLAN systems, the APs generate beacon signals and supplemental beacon signals at periodic intervals known to all stations in the BSS. VoWLAN stations uses their local timer to schedule the reception of beacons. If there is a significant timing error, the station must use a longer search period to receive a beacon. The longer search period causes uses up precious battery charge and counteracts the benefit of low power operation. Furthermore, the timing error could also cause a missreception of a beacon, which impacts battery life and radio resource measurements since the station uses the signal strength from received beacons in its roaming decision making process

Therefore, there is a need for a means by which a station may use low power modes, including using low frequency clocks while in low power mode, and still be able to maintain synchronization with an access point.

### BRIEF DESCRIPTION OF THE DRAWINGS

FIG. 1 shows a schematic block diagram of a wireless local area network (WLAN) system for use in a mobile station, in accordance with an embodiment of the invention;

FIG. 2 shows a WLAN system including a mobile station and an access point;

FIG. 3 shows an uplink poll based power save delivery signal diagram for facilitating power save operation in a mobile station operating in a WLAN;

FIG. 4 shows a signal diagram of a traffic stream with beacon signals transmitted by a WLAN access point;

FIG. 5 shows a frame transmitted by a WLAN access point while servicing a traffic stream;

FIG. 6 shows a quality of service control subfield as transmitted by a WLAN access point while servicing a traffic stream in accordance with one embodiment of the invention; and

FIG. 7 shows a payload delivery for facilitating synchronization of a mobile station with an access point, in accordance with one embodiment of the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. The invention solves the problem of a mobile station's timer falling out of synchronization with the access point's timer as a result of transitioning in and out of low power operation by delivering timing and synchronization information to the mobile station in the course of servicing a traffic stream, and other requests by the mobile station. By transmitting access point timing information to the mobile station each service period, the error resulting from transitioning from low power mode to active mode and back to low power mode in the mobile station's clock will be substantially reduced.

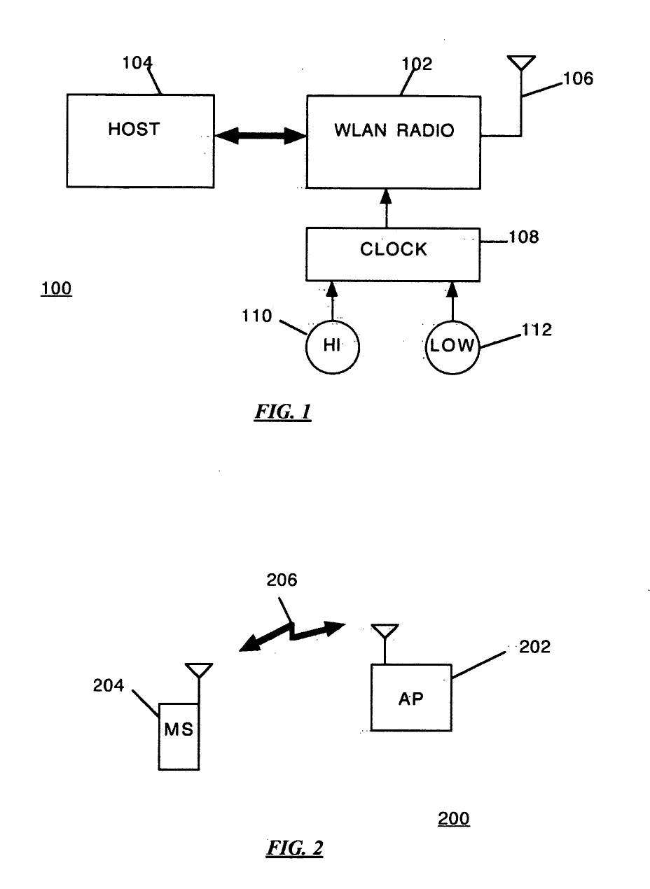

Referring now to FIG. 1, there is shown a schematic block diagram 100 of a wireless local area network (WLAN) system for use in a mobile station, in accordance with an embodiment of the invention. The WLAN system includes a WLAN radio 102 which provides access to the radio channel for a host processor 104. The WLAN radio performs all of the transmission and reception, modulation and demodulation, encryption and decryption, timing, channel contention, and so on, so that data may be transmitted and received. The radio 102 is coupled to an antenna 106, which is typically a diversity antenna comprised of 2 antenna elements. The radio timing is performed by use of a clock 108. According to the invention, the clock is driven by either of two clock sources; a high frequency clock source 110 and a low frequency clock source 112. The high frequency clock source is used while the WLAN radio is in the active mode. That is, while transmitting or receiving data, and performing related operations. The low frequency clock source is used when the WLAN radio is in a low power mode. The low power mode results when the WLAN radio is shut down, so as to consume little or no power. Since WLAN activity is periodic and typically short in duration, the WLAN radio can be shut down when not needed, resulting in a substantial power savings, which results in prolonged operation of a battery powered mobile station. The clock allows the radio to become active at the right time so as to service traffic stream and receive periodic signals from the access point. If a mobile station misses reception of a periodic signal, then it may have to remain in active mode until it is transmitted again by the access point. Therefore timing is crucial so as to avoid missing transmissions from the access point.

In FIG. 2 a WLAN system 200 including a mobile station 204 and an access point 202 is shown. As is known, the mobile station and access point interact via a radio channel 206. The mobile station associates with the access point, and remains associated with the access point so long as the signal received over the radio channel is of sufficient quality. If the mobile station is physically moved, it may associate with other access points as the quality of the signal changes and other access points proved a better quality signal.

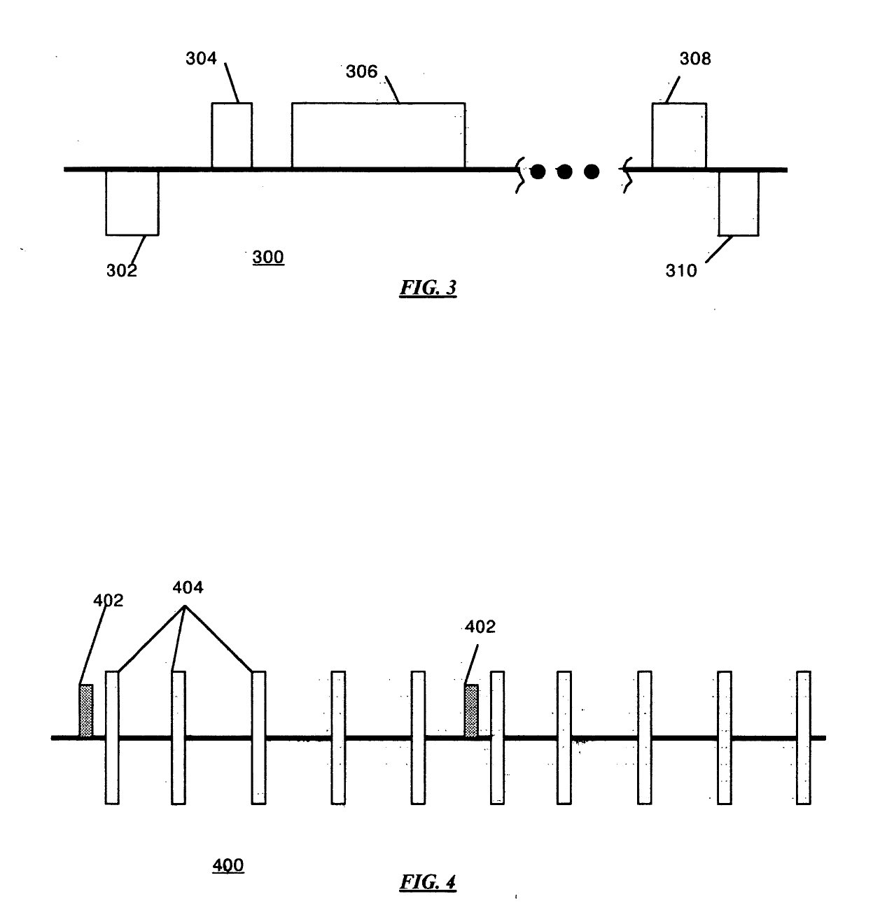

Referring now to FIG. 3, there is shown an uplink poll based power save delivery (UPSD) signal diagram 300 for facilitating power save operation in a mobile station operating in a WLAN. The diagram shows transactions between a mobile station and an associated access point during a service period, and is divided into top and bottom sections with the bottom section representing transmissions by the mobile station, and the top representing a response sequence of transmissions by the access point. To initiate the method, the mobile station transitions from a low power mode to an active mode, and acquires the channel by transmitting a poll or trigger frame 302. The poll frame includes a traffic stream identifier associated with a particular traffic stream in which the mobile station is presently engaged, and for which the access point may have data. Typically the access point initially responds with an acknowledgement frame 304, followed by one or more payload frames 306. At the end of the access point's response sequence a final frame 308 is transmitted. The final frame may be the only frame transmitted if the access point has no data to transmit to the mobile station. The final frame indicates to the mobile station that the service period is over, and no more frames will be transmitted to the mobile station in the present service period. The mobile station will typically acknowledge the final frame with a acknowledgment frame 310. In one embodiment of the invention, it is contemplated that the final frame 308 may be a timer update frame, and may include a present timer value, or a portion of the timer value of the access point's timer, so that the mobile station can adjust its local timer/clock. A timer update frame may equivalently be transmitted anywhere in the response sequence. A service period for real time traffic streams, such as voice or video, occurs at regular intervals. For example, a voice stream may be serviced every 20 milliseconds in a WLAN system. In a UPSD system, the mobile station must wake itself up at the appropriate time to poll the access point and receive any data buffered at the access point destined for the mobile station. Likewise, the WLAN radio will transmit data buffered by the host processor during the time the WLAN radio is in low power mode between service periods.

Referring now to FIG. 4, there is shown a signal diagram 400 of a traffic stream with beacon signals 402 transmitted by a WLAN access point. As with FIG. 3, the top portion represents transmissions by the access point and the bottom represent transmissions by the mobile station. The beacons signals are transmitted at regular intervals, typically on the order of every 100 milliseconds as according to IEEE specification 802.11. The beacon signals contain timing information regarding the access point's timer, which allows stations to synchronize with the access point. In between beacons, the mobile station initiates service periods, such as those indicated by bars 404. Each service period 404 may be similar to that illustrated by FIG. 3, and since service periods involve transmissions by both access point and mobile station, the bars shown here are both above and below the center line. During a service period the mobile station is operating in active mode, and in between service periods and beacons, and possibly during some beacon transmissions, the mobile station places the WLAN radio in a low power mode. Preferably the low power mode includes the use of a low frequency clock source while in the low power mode. When the mobile station transitions in and out of low power mode, and changes which clock source it uses, without making any correction, errors introduced in the mobile station's clock as a result of transitioning are compounded with each transition. Subsequently, when the mobile station desires to receive a beacon transmission, which occurs at a scheduled time, the timing error at the mobile station can be so great that it misses the beacon transmission and then must remain in active mode until the access point transmits a subsequent beacon.

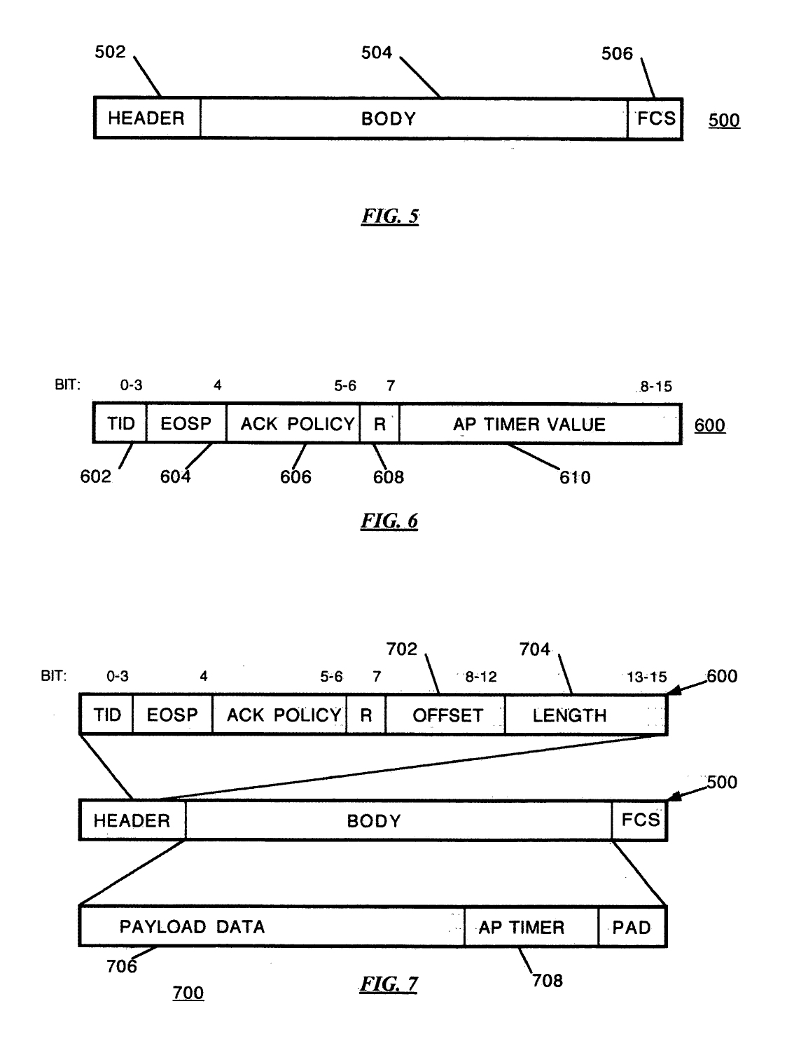

Referring now to FIGS. 5-7 there are shown a frame 500 transmitted by a WLAN access point while servicing a traffic stream; a quality of service control subfield 600 as transmitted by a WLAN access point while servicing a traffic stream; and a payload delivery 700 for facilitating synchronization of a mobile station with an access point, in accordance with one embodiment of the invention, respectively. Each frame 500 includes a header 502 with various control parameters and other information used by the receiving entity to determine what information is in the body 504, which may include data. A frame check sequence 506 is also provided at the end of the frame for error detection. In frames associated with certain traffic streams a quality of service (QoS) control subfield 600 is included in the frame header 502. The QoS control subfield may include a traffic stream identifier 602 for identifying the particular traffic stream to which the present frame belongs. Further included may be an end of service period bit 604 for indicating if the present frame is the last one to be transmitted during the present service period. Further, an acknowledgement policy field 606 may be included to indicate the protocol for acknowledging receipt of the present frame by the intended receiver. Some field space may be reserved 608. According to one embodiment of the present invention, some of the QoS control subfield contains a portion of a present value of the access point's timer value 610. For example, the field may contain a copy of one byte of the access point's timer at the time the frame was transmitted. Since the access point's timer is typically several bytes wide, with higher bits representing much larger time intervals, only the portion of the timer where errors are likely to occur needs to be transmitted. For example, in a IEEE specification 802.11 system, the access point's timer is such that the second least significant byte of the timer has resolution from 256 microseconds (least significant bit) to 65.28 milliseconds. Given that beacon intervals are 100 milliseconds apart, it is likely that the timing errors introduced in the mobile station's clock by transitioning from high frequency clock source to low frequency clock source and back can be corrected by comparing the second least significant byte of the mobile station's clock with that of the access point.

Alternatively, the access point timer information may be delivered in the body 504. n another embodiment of the invention the QoS control subfield 600 includes an offset field 702 and a length field 704 for indicating the position and length of the timer information in the body 504. The body may include payload data 706, such as voice data for a call in progress. The timer information 708 appears in the body beginning at the point corresponding to the offset field 702, and occupying a length indicated by the length field 704. However the mobile station receives the timer information, once it is received, it updates the received timer information with its local clock, and corrects errors indicated by significant differences between its local clock and the timer information.

Therefore the invention provides a method for updating the timer of a mobile station in a wireless local area network, commencing with receiving a trigger frame at the access point for initiating a service period. During the service period the access point services a traffic stream identified in the trigger frame. In response to the trigger frame, the access point transmits to the mobile station a response sequence, including a timer value that is at least a portion of the present value of the access point's timer. The timer value may be transmitted in a quality of service control subfield of a frame in the response sequence. The timer value may be the second lowest byte of the timer function of the access point. The timer value may alternatively be placed in a body of a frame of the response sequence, with the frame header containing information about the location of the timer value in the body of the frame. Alternatively the timer value may be transmitted in a timer update frame of the response sequence. If the timer update frame is the final frame of a response sequence, the timer update frame may contain an end of end of service period field set to indicate an end of the present service period.

From the mobile station the invention provides a method for updating a timer function of the mobile station, which commences by transmitting a trigger frame for initiating a present service period. In response the access point transmits, and the mobile station receives a response sequence, including a timer value that is at least a portion of a present value of a timer function of the access point. The mobile station uses the timer value to update its local timer.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for updating a timer function in a mobile station in a wireless local area network, comprising:
receiving from the mobile station at an access point a trigger frame for servicing a traffic stream in a present service period; and
transmitting to the mobile station from the access point a response sequence, including a timer value that is at least a portion of a present value of a timer function of the access point.

2. A method for updating a timer function in a mobile station as defined by claim 1, wherein transmitting to the mobile station comprises placing the timer value in a quality of service control subfield of a frame in the response sequence.

3. A method for updating a timer function in a mobile station as defined by claim 2, wherein the timer value is the second lowest byte of the timer function of the access point.

4. A method for updating a timer function in a mobile station as defined by claim 1, wherein transmitting to the mobile station comprises placing the timer value after a payload in a frame of the response sequence, and wherein the frame has a header, the header containing information about the location of the timer value in the payload of the frame.

5. A method for updating a timer function in a mobile station as defined by claim 1, wherein the timer value is transmitted in a timer update frame of the response sequence.

6. A method for updating a timer function in a mobile station as defined by claim 5, wherein the timer update frame contains an end of end of service period field set to indicate an end of the present service period.

7. A method for updating a timer function in a mobile station in a wireless local area network, comprising:
transmitting from the mobile station to an access point a trigger frame for initiating a present service period for servicing a traffic stream;
receiving at the mobile station from the access point a response sequence, including a timer value that is at least a portion of a present value of a timer function of the access point; and
updating a local timer of the mobile station with the timer value.

8. A method for updating a timer function in a mobile station as defined by claim 7, wherein receiving at the response sequence comprises receiving the timer value in a quality of service control subfield of a frame in the response sequence.

9. A method for updating a timer function in a mobile station as defined by claim 8, wherein the timer value is the second lowest byte of the timer function of the access point.

10. A method for updating a timer function in a mobile station as defined by claim 7, wherein receiving comprises receiving the timer value after a payload in a frame of the response sequence, and wherein the frame has a header, the header containing information about the location of the timer value in the payload of the frame.

11. A method for updating a timer function in a mobile station as defined by claim 7, wherein the timer value is received in a timer update frame of the response sequence.

12. A method for updating a timer function in a mobile station as defined by claim 11, wherein the timer update frame contains an end of end of service period field set to indicate an end of the present service period.

13. A method for updating a timer function in a mobile station in a wireless local area network, comprising:
waking up a wireless local area network subsystem of the mobile station from a low power mode, and wherein a low frequency clock source is used for driving a local timer while in the low power mode;
upon waking up from the low power mode to an active mode, switching to a high frequency clock source for driving the local timer during the active mode;
transmitting from the mobile station to an access point a trigger frame for initiating a present service period for servicing a traffic stream;
receiving at the mobile station from the access point a response sequence, including a timer value that is at least a portion of a present value of a timer function of the access point;
updating the local timer with the timer value; and
reentering the low power mode, and switching to the low frequency clock source for driving the local timer.

14. A method for updating a timer function in a mobile station as defined by claim 13, wherein receiving at the response sequence comprises receiving the timer value in a quality of service control subfield of a frame in the response sequence.

15. A method for updating a timer function in a mobile station as defined by claim 14, wherein the timer value is the second lowest byte of the timer function of the access point.

16. A method for updating a timer function in a mobile station as defined by claim 13, wherein receiving comprises receiving the timer value after a payload in a frame of the response sequence, and wherein the frame has a header, the header containing information about the location of the timer value in the payload of the frame.

17. A method for updating a timer function in a mobile station as defined by claim 13, wherein the timer value is received in a timer update frame of the response sequence.

18. A method for updating a timer function in a mobile station as defined by claim 17, wherein the timer update frame contains an end of end of service period field set to indicate an end of the present service period.
